(19) United States
(12) Patent Application Publication
(10) Pub. No.: US 2012/0261448 A1
(43) Pub. Date: Oct. 18, 2012

(54) License plate mounting apparatus

(76) Inventor: Robert M. O'Neil, Santa Monica, CA (US)

(21) Appl. No.: 13/506,318

(22) Filed: Apr. 11, 2012

Related U.S. Application Data
(60) Provisional application No. 61/474,272, filed on Apr. 12, 2011.
(60) Provisional application No. 61/521,267, filed on Aug. 8, 2011.

(51) Int. Cl. B60R 7/05

(52) U.S. Cl. 224/277

(57) ABSTRACT

The invention is an automobile license plate mounting apparatus adapted to be coupled to or incorporated into a vehicle visor. A substantially rectangular, planar member is provided with securing means extending upwardly from the bottom and side edges of the front surface of said planar member. The securing member includes a contiguous flange extending from the edges of said planar member and a clamping panel disposed perpendicular to said contiguous flange and parallel to the front surface of said planar member to maintain the license plate adjacent the front surface of the planar panel. First and second securing members are affixed to the rear surface of the rectangular panel to secure the license plate holder to a vehicle visor. The securing members are obliquely positioned with respect to each other to horizontally position the license plate holder.

Pursuant to 35 U.S.C. §119(e) and 37 C.F.R. §1.53(c)(3), Applicant claims the benefit of Provisional Patent Application Nos. 61/474,272 and 61/521,267 filed Apr. 12, 2011 and Aug. 8, 2011, respectively.

### BACKGROUND OF THE INVENTION

1. Field of the Invention

The present invention generally relates to apparatus for mounting a vehicle license plate and in particular to license plate mounting apparatus adapted to be secured to a vehicle visor.

2. Description of the Prior Art

In recent years, many states have required that vehicles display a license plate that can be viewed from the front of the vehicle. However, since attachment of a vehicle license plate on the bumper or grill of a vehicle can be expensive or unsightly, or both, there is a need for an improved license holder to display a license plate that may be viewed from the front of the vehicle.

A device taught by the prior art consists of a first mounting element that is permanently affixed under the vehicle bumper or within the vehicle grill and a second element to which the vehicle license plate is secured and which can be removably affixed to the permanently mounted first element. When desired, the second element and the license plate can be removed from the vehicle. The problems inherent in this device are complexity and expense. These problems are resolved by the present invention which employs a planar mounting holder to which a vehicle license plate may be coupled, the apparatus being adapted to be secured to a visor within the cabin of a vehicle.

Another device taught by the prior art consists of a holding apparatus that may be secured to the interior surface of the windshield. The inherent problem with the device is that, when it is in use, the visibility of the driver and/or a passenger within the car is obscured thereby creating a dangerous condition when the vehicle is in motion. The present invention resolves this problem by providing a device that may be mounted to a visor rotatably positioned at the top of the vehicle windshield in a manner that does not obscure the driver's view of road conditions.

### SUMMARY OF THE INVENTION

The present invention comprises a vehicle license plate mounting apparatus that is adapted to be coupled to a windshield visor within the cabin of a vehicle. Vehicle visors are commonly used in automobiles and other vehicles and are generally rotatably positionable adjacent the upper portion of the vehicle windshield. When the visor is in a lowered position, the front surface thereof is positioned adjacent the windshield of the vehicle. The present invention is adapted to be mounted upon the front surface of the vehicle visor.

The present invention comprises a generally rectangular mounting support having front and rear surfaces. A contiguous flange extends upwardly from the front surface of the planar member along the bottom and both side edges of the planar member. The upwardly extent of the contiguous flange is uniformly spaced from the front surface of the planar mounting support. The entire upper edge of the contiguous flange depends inwardly into an extension element that is in parallel spaced relation to the front surface of the planar mounting support forming a uniform slot within which the license plate may be inserted and securely positioned.

First and second connecting members are secured to the rear surface of the planar mounting support. In the preferred embodiment of the present invention, apparatus are disposed through each connecting member to position connecting straps. In order to compensate for the variations in the roof lines of vehicles, one of the connecting members is obliquely positioned with respect to the other. The oblique angle formed between the bottom edge of the planar mounting support and the relationship between the connecting members compensates for the roof line thereby permitting a mounted vehicle license plate to be viewed horizontally and in parallel spaced relation to the driving surface on the which the vehicle is moving.

It is an object of the present invention to provide a vehicle license plate holder that can be attached to a vehicle visor and viewed from the front of the car.

It is another object of the present invention to provide an improved license plate holder that may be attached to a vehicle visor that permits the horizontal positioning of the license plate.

It is still another object of the present invention to provide a vehicle license plate holder that provides for easy replacement of a license plate.

It is still yet another object of the present invention to provide a license plate holder that is attachable to a vehicle visor that is simple and inexpensive to fabricate.

The novel features which are believed to be characteristic of the invention, both as to its organization and method of operation, together with further objectives and advantages thereof, will be better understood from the following description considered in connection with the accompanying drawing in which a presently preferred embodiment of the invention is illustrated by way of example. It is to be expressly understood, however, that the drawing is for the purpose of illustration and description only, and is not intended as a definition of the limits of the invention.

### DESCRIPTION OF THE DRAWINGS

FIG. 1 illustrates a front elevation view of the present invention illustrating the positioning of a vehicle license plate.

FIG. 2 is a rear elevation view of the present invention vehicle license plate holder illustrating the oblique positioning of the connecting members.

FIG. 3 is a partial, cross-section view of the flange and extension element of the planar mounting support shown in FIG. 1 taken through line 3-3 of FIG. 1.

FIG. 4 is a cross-section view of a connecting member as shown in FIG. 2 taken through line 4-4 of FIG. 2.

FIG. 5 illustrates the present invention mounted on an automobile visor as viewed from the outside from a vantage point forward of the vehicle.

FIG. 6 illustrates the present invention mounted on an automobile visor as viewed from a vantage point to the rear of and inside the vehicle.

FIG. 7 illustrates an alternative embodiment of the present invention wherein the mounting support for a license plate is directly secured to an automobile visor.

FIG. 8 is a cross-sectional view of the alternative embodiment of the present invention shown in FIG. 7 taken through line 8-8 of FIG. 7.

### DESCRIPTION OF THE PRESENTLY PREFERRED EMBODIMENT

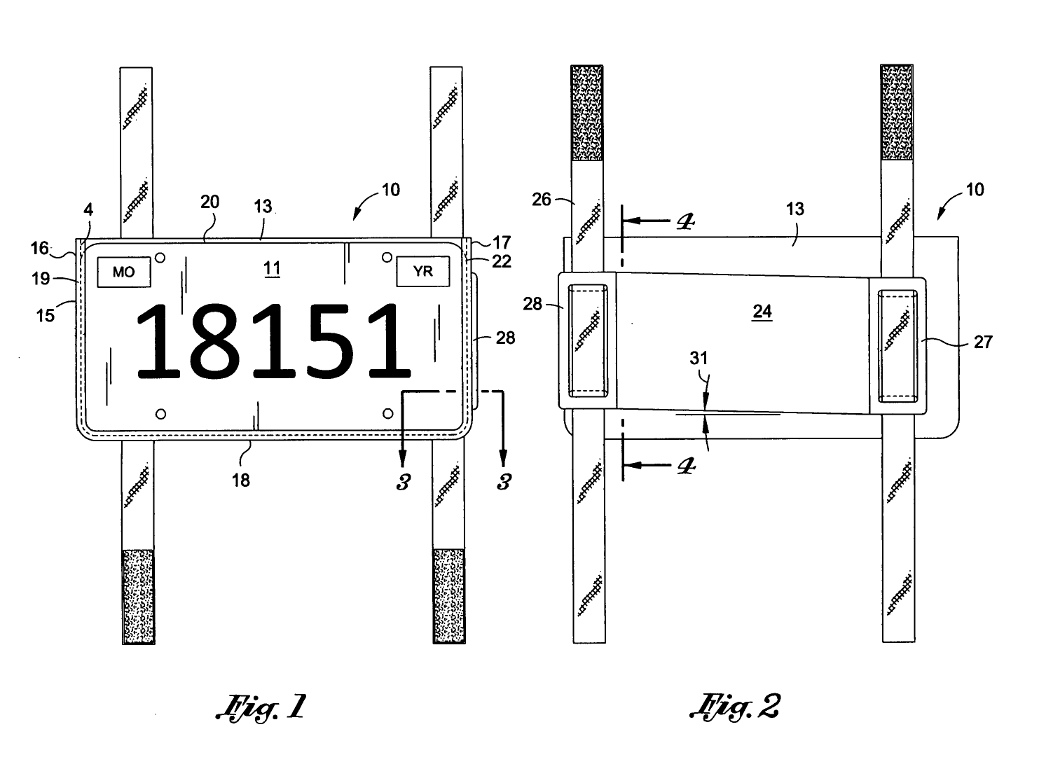

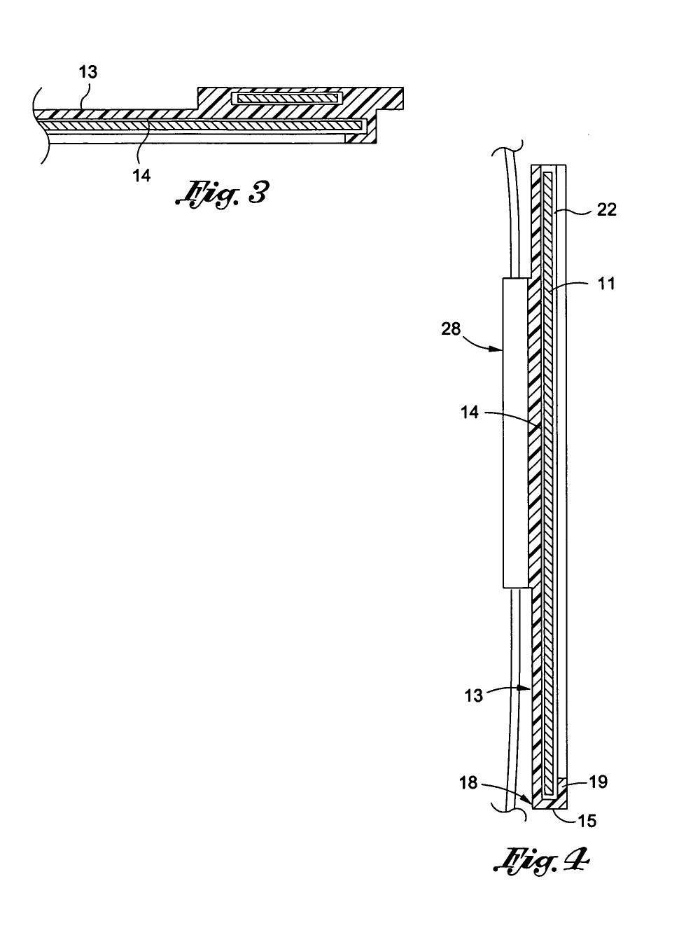

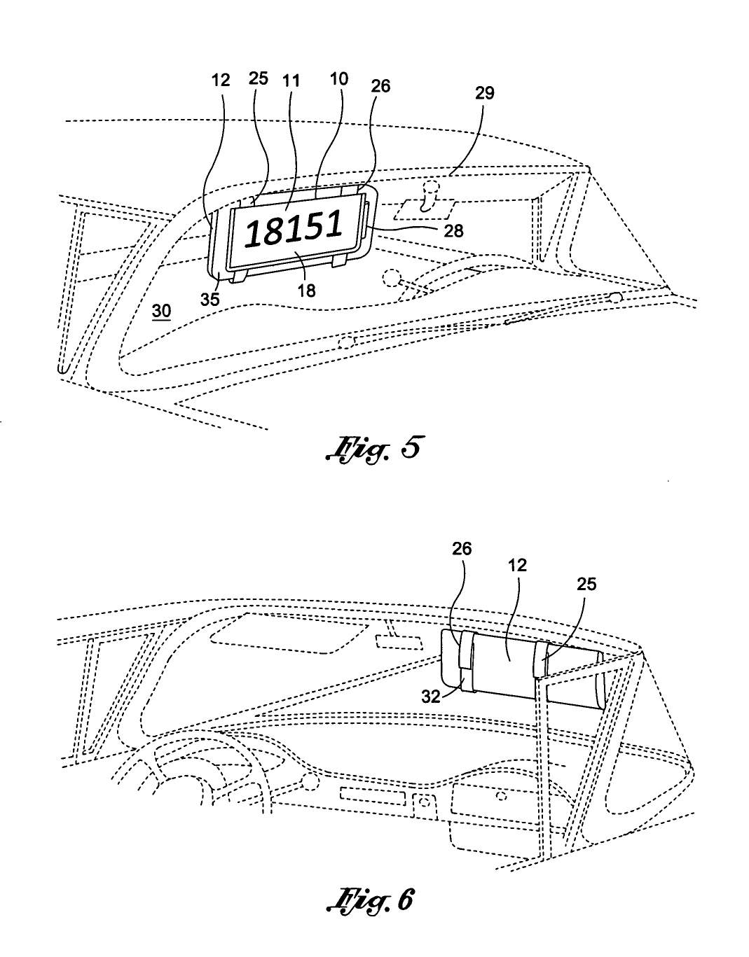

An understanding of the present invention can be best gained by reference to FIGS. 1-4, inclusive, the present invention license mounting apparatus being generally designated by the reference numeral 10. As will be described in detail hereinbelow, the present invention is intended to removably receive a vehicle license plate 11 and be mounted upon a vehicle visor 12 within the cabin of a motor vehicle (see FIGS. 5 and 6). The license plate receiving member 13 comprises a substantially rectangular planar member having a height and width that are greater than a vehicle license plate 11.

The present invention is intended to removably but snugly maintain a vehicle license plate adjacent the front surface 14 of receiving member 13. To accomplish this, a receiving flange 15 depends upwardly from front surface 14 of receiving member 13 along the opposed side edges 16 and 17 and bottom edge 18. The receiving flange 15 extends into a holding member 19 perpendicular to receiving flange 15 and in parallel spaced relation to front surface 14 contiguously along the entire length of receiving flange 15. As can be seen best in FIG. 4, license plate 11 is adapted to be positioned disposed adjacent front surface 14 and be held in place by the close proximity as forces imposed by receiving flange 15 and holding member 19. To permit the replacement of license plate 11 from the present invention, the upper edge 20 of license plate 11 extends above the ends 21 and 22 of holding member 19.

It is an objective of the present invention to provide an improved license plate holding apparatus that can be mounted upon a visor 12 generally positioned at the upper margin of the vehicle windshield 30 within the cabin thereof (see, FIGS. 5 and 6). In the preferred embodiment of the present invention, the license plate holding apparatus 10 is mounted upon visor 12 through the use of connecting straps 25 and 26. Although the preferred embodiment of the present invention employs connecting straps 25 and 26, it will be understood by those having skill in the art that other removable connecting means such as Velcro and the like can be used in lieu of connecting straps 25 and 26. It would be further understood by those having skill in the art that the rear surface 24 of the license plate receiving member 13 could be directly coupled to a vehicle visor 12 through the use of conventional removable coupling means.

In the preferred embodiment of the present invention, the license plate holding apparatus employs connecting straps 25 and 26 that are engaged to securing members 27 and 28, respectively. As shown in FIG. 2, securing members 27 and 28 are mounted upon to the rear surface 24 of license plate receiving member 13. As can be seen best in FIG. 5, the interface between the vehicle roof 29 and windshield 30 generally extends downwardly from the center of the roof line. As a result, in order for a license plate 11 to be fully visible from the front of the vehicle when the visor is in a lowered position as shown in FIGS. 5 and 6, the positioning of the present invention 10 on the visor must adjust for the downward slope of the roof line 29. If no adjustment is made, a portion of the license plate may be obscured.

As shown in FIG. 2, the preferred embodiment of the present invention includes the angular deflection between the position of securing members 27 and 28 and the lower edge of the license plate receiving member 13, the angular deflection being defined by an angle identified by reference numeral 31. The angle defined by the reference numeral 31 is the equivalent of the angle between the slope of the vehicle roof line 29 and a horizontal plane defined by the surface on which the vehicle moves. The magnitude of the oblique angle 31 will be determined by the roof line of the vehicle on which the present invention is used. Since the positioning of the present invention license plate holding apparatus 10 upon visor 12 will be adjusted for the slope of the vehicle roof line 29, when the visor is in its lower position license plate 11 will be fully in view from the front of the vehicle. Although the preferred embodiment of the present invention includes an angular deflection between the position of the securing members 27 and 28, it is understood that securing members 27 and 28 may be mounted in uniform alignment with bottom edge 18 of receiving member 13.

The manner in which the present invention 10 is used can be best seen in FIGS. 5 and 6. In FIGS. 5 and 6, vehicle visor 12 is illustrated in the lowered position. To mount the license plate mounting apparatus 10, the rear surface 24 of license plate receiving member 13 is disposed against the frontal surface 35 of visor 12, edge 18 of receiving member 13 being substantially parallel to vehicle roof line 29. Connection straps 25 and 26 are disposed about visor 12 and secured by a conventional coupling identified by the reference numeral 32. When necessary, the present invention provide the convenience of being able to remove the front license plate from view merely by rotating visor 12 upwardly toward vehicle roof line 29. Similarly, when required to comply with vehicle regulations, visor 12 can be lowered thereby allowing the mounted license plate to be fully viewed from the front of the vehicle.

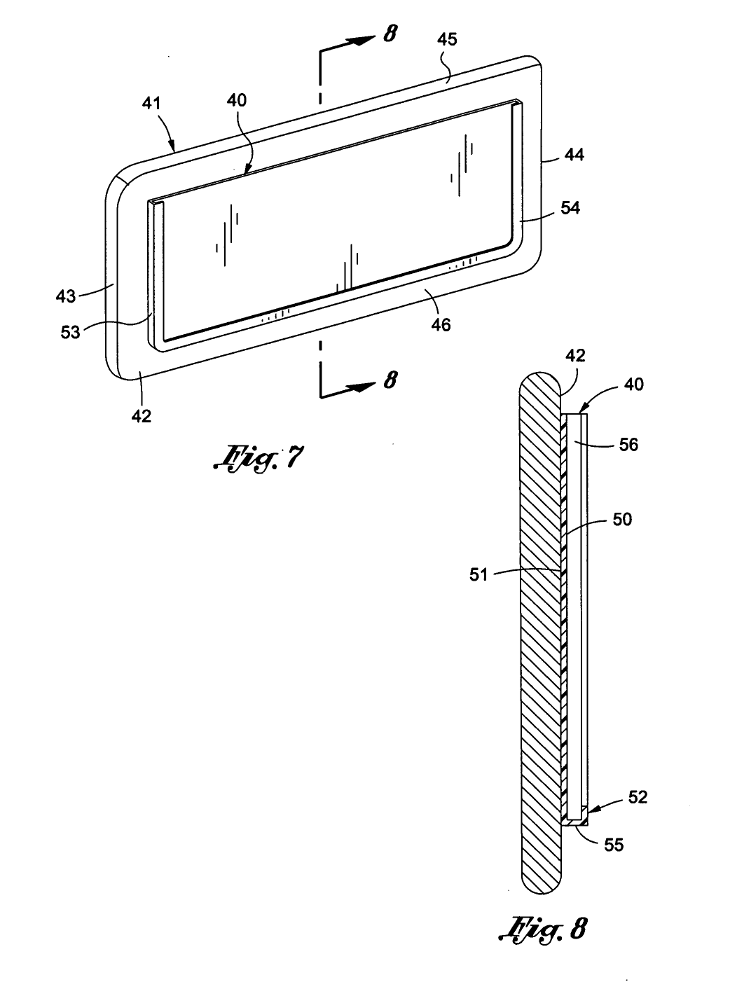

An alternative embodiment of the present invention can be best seen in FIGS. 7 and 8 wherein a license plate receiving member 40 is directly secured to a vehicle visor 41. As shown in FIG. 7, visor 41 is illustrated as a rectangular member having a top surface 42 defined by parallel side surfaces 43 by side edges 43 and 44 and top and bottom edges 45 and 46. It would be understood by those persons having skill in the art that visor 41 could employ a geometrical configuration other than rectangular, the rectangular form for visor 41 being for illustration only. In the same manner as described with respect to license plate receiving member 13, license plate receiving member 40 is rectangular and has a front surface 50 and a rear surface 51. A receiving flange 52 depends upwardly from front surface 50 along opposed edges 53 and 54 and bottom edge 55. The receiving flange 52 extends into a holding member 56 perpendicular to receiving flange 52 and in parallel spaced relation to front surface 50 contiguously along the entire length of receiving flange 55. In the alternative embodiment of the present invention shown in FIGS. 7 and 8, rear surface 51 of license plate receiving member 40 is directly secured to the top surface of visor 41 without the need of securing members 27 and 28 or the like.

I claim:

1. A license plate mounting apparatus for use with a vehicle visor having a visible surface comprising:
(a) a planar license plate receiving member having a front and a rear surface and top, bottom and side edges;
(b) a uniform receiving flange depends upwardly from the front surface of said license plate receiving member along the opposed side edges and the bottom edge thereof, a plate holding member extending inwardly from the upper terminus of said receiving flange spaced above the front surface of said license plate receiving member and being in parallel spaced relation thereto; and
(c) securing means for coupling the rear surface of the license plate receiving member to the visible surface of the vehicle visor.

2. A license plate mounting apparatus as defined in claim 1 wherein said securing means comprises:
(a) first and second mounting members secured to the rear surface of the license plate receiving member; and
(b) first and second straps coupled to said first and second mounting members respectively, said first and second straps being adapted to removably secure the rear surface of said license plate receiving member adjacent the visible surface of the vehicle visor.

3. A license plate mounting apparatus as defined in claim 2 wherein said first and second mounting members are uniformly secured to the rear surface of said license plate receiving member in uniform relationship to the bottom edge thereof.

4. A license plate mounting apparatus as defined in claim 2 wherein said first and second mounting members are secured to the rear surface of said license plate receiving member in an oblique relationship to the bottom edge thereof.

5. A license plate mounting apparatus as defined in claim 1 wherein said receiving flange is contiguous along the opposed side edges and the bottom edge of said license plate receiving member.

6. A license plate mounting apparatus as defined in claim 5 wherein said holding member is contiguous along the entire upper terminus of said receiving flange.

7. A license plate mounting apparatus as defined in claim 1 wherein said securing means is integral with the rear surface of the license plate receiving member and the visible surface of the vehicle visor.
